(19) United States
(12) Patent Application Publication
(10) Pub. No.: US 2021/0201383 A1
(43) Pub. Date: Jul. 1, 2021

(54) METHOD, APPARATUS, AND DEVICE FOR PROCESSING PRODUCT TRANSACTIONS

(71) Applicant: Alibaba Group Holding Limited, Grand Cayman (KY)

(72) Inventor: Fei HU, Hangzhou (CN)

(21) Appl. No.: 16/973,682

(22) PCT Filed: Jun. 10, 2019
(86) PCT No.: PCT/CN2019/090506

§ 371 Date: Dec. 9, 2020

(30) Foreign Application Priority Data
Jun. 19, 2018 (CN) 201810628866.5

(51) Int. Cl. G06Q 30/06; G06Q 20/42; G06Q 20/40

(52) U.S. Cl. CPC G06Q 30/0635; G06Q 30/0641; G06Q 20/40145; G06Q 20/42

(57) ABSTRACT

Embodiments of the disclosure provide a method, an apparatus, and a device for processing product transactions. The method comprises: acquiring, via an offline transaction system, identification information of a user; querying an online transaction system for an unfulfilled product based on the identification information of the user, the unfulfilled product being in an online order associated with the user in the online transaction system; providing product information of the unfulfilled product in the offline transaction system to the user; and allowing the user to complete a transaction of the unfulfilled product in the offline transaction system.

### CROSS-REFERENCE TO RELATED APPLICATIONS

The present application is a national stage entry of Int'l Appl. No. PCT/CN2019/090506, filed on Jun. 10, 2019, which claims priority to the Chinese Patent Application No. 201810628866.5 filed on Jun. 19, 2018, both of which are incorporated by reference herein in their entirety.

### BACKGROUND

### Technical Field

The disclosure relates to the field of computer technologies, and in particular, to methods, apparatuses, and devices for processing product transactions.

### Description of Related Art

E-commerce refers to commercial activities focusing on product exchanges leveraging information network technologies. E-commerce also covers activities of electronic transactions and related services provided on networks such as the Internet, enterprise intranets, and value-added networks (VANs).

Accordingly, a user can shop online by visiting an e-commerce website or using related application software on a mobile electronic device. However, for an online purchased product that is in urgent need by the user, if the online order is in an unfulfilled state (e.g., the product not been shipped yet, or the product is being delivered), the user may still need to purchase the product from an offline physical store.

Therefore, there exists a need for solutions to process product transactions to correlate online shopping with offline shopping.

### SUMMARY

Embodiments of the disclosure provide methods, apparatuses, and devices for processing product transactions to solve the problem of mutual independence between online shopping and offline shopping in the present technologies, as well as the resultant inconvenience in shopping.

Embodiments of the disclosure provide the following technical solutions.

In one embodiment, the disclosure provides a method for processing product transactions, the method comprising acquiring, via an offline transaction system, identification information of a user; querying, based on the identification information of the user, an online transaction system for an unfulfilled product in an online order of the user in the online transaction system; and providing product information of the unfulfilled product in the offline transaction system to the user such that the user completes a transaction of the unfulfilled product in the offline transaction system.

In one embodiment, querying, based on the identification information of the user, an online transaction system for an unfulfilled product in an online order of the user in the online transaction system comprises: sending a query request to the online transaction system, the query request including the identification information of the user; receiving a query result returned by the online transaction system based on the identification information of the user; and determining, based on the query result, the unfulfilled product in the online order of the user in the online transaction system.

In one embodiment, providing product information of the unfulfilled product in the offline transaction system to the user comprises: upon determining that the unfulfilled product is stocked in a local product repository of the offline transaction system, providing the product information of the unfulfilled product in the local product repository to the user.

In one embodiment, providing product information of the unfulfilled product in the offline transaction system to the user comprises: displaying, via a display screen of the offline transaction system, the product information of the unfulfilled product to the user. In another embodiment, providing product information of the unfulfilled product in the offline transaction system to the user comprises: sending, via the online transaction system, the product information of the unfulfilled product to a client device of the user for displaying to the user.

In one embodiment, the method further comprises: acquiring a difference between a transaction amount of the unfulfilled product in the online transaction system and a transaction amount of the unfulfilled product in the offline transaction system; and providing the difference to the user such that the user completes the transaction based on the difference in the transaction amount.

In one embodiment, the method further comprises: acquiring an authorization instruction from the user, the authorization instruction being used to indicate that the user authorizes the transaction; and transmitting, to the online transaction system based on the authorization instruction and the difference in transaction amount, a request for performing the transaction.

In one embodiment, the method further comprises: sending an order status modification instruction to the online transaction system such that the online transaction system updates an order status for an online order of the unfulfilled product.

In one embodiment, acquiring identification information of a user comprises: acquiring a facial image of the user located in an image acquisition area of the offline transaction system to determine the identification information of the user. In another embodiment, acquiring identification information of a user comprises: acquiring account information of the user during a transaction via the client device of the user; and designating the account information as the identification information of the user. In another embodiment, acquiring identification information of a user comprises: acquiring a facial image input by the user via a self-service query device of the offline transaction system to determine the identification information of the user. In another embodiment, acquiring identification information of a user comprises: acquiring account information input by the user via a self-service query device of the offline transaction system; and designating the account information as the identification information of the user.

In one embodiment, the disclosure provides a method for processing product transactions, the method comprising: receiving, via an online transaction system, a query request sent from an offline transaction system, the query request including identification information of a user; and querying, based on the identification information of the user, for an unfulfilled product in an online order of the user in the online transaction system to provide product information of the unfulfilled product in the offline transaction system to the user such that the user completes a transaction of the unfulfilled product in the offline transaction system.

In one embodiment, the method further comprises: sending the unfulfilled product information to the offline transaction system to query whether the unfulfilled product is stocked in a local product repository of the offline transaction system.

In one embodiment, the method further comprises: sending the product information of the unfulfilled product to a client device of the user for displaying to the user.

In one embodiment, the disclosure provides an apparatus for processing product transactions, the apparatus comprising: an acquisition module configured to acquire identification information of a user; a query module configured to query, based on the identification information of the user, an online transaction system for an unfulfilled product in an online order of the user in the online transaction system; and a prompt module configured to provide product information of the unfulfilled product in the offline transaction system to the user such that the user completes a transaction of the unfulfilled product in the offline transaction system.

In one embodiment, the disclosure provides an apparatus for processing product transactions, the apparatus comprising: a receiving module configured to receive a query request sent from an offline transaction system, the query request including identification information of a user; and a query module configured to query, based on the identification information of the user, for an unfulfilled product in an online order of the user in the online transaction system to provide product information of the unfulfilled product in the offline transaction system to the user such that the user completes a transaction of the unfulfilled product in the offline transaction system.

In one embodiment, the disclosure provides an electronic device, the electronic device comprising: a processor; and a memory configured to store computer-executable instructions, when executed by the processor, causing the electronic device to perform the operations of acquiring identification information of a user; querying, based on the identification information of the user, an online transaction system for an unfulfilled product in an online order of the user in the online transaction system; and providing product information of the unfulfilled product in the offline transaction system to the user such that the user completes a transaction of the unfulfilled product in the offline transaction system.

In one embodiment, the disclosure provides a computer-readable medium, wherein the computer-readable medium stores one or more programs, when executed by an electronic device comprising a plurality of application programs, causing the electronic device to perform the operations of: acquiring identification information of a user; querying, based on the identification information of the user, an online transaction system for an unfulfilled product in an online order of the user in the online transaction system; and providing product information of the unfulfilled product in the offline transaction system to the user such that the user completes a transaction of the unfulfilled product in the offline transaction system.

In one embodiment, the disclosure provides an electronic device, the electronic device comprising: a processor; and a memory configured to store computer-executable instructions, when executed by the processor, causing the electronic device to perform the operations of: receiving a query request sent by an offline transaction system, the query request including identification information of a user; and querying, based on the identification information of the user, for an unfulfilled product in an online order of the user in the online transaction system to provide product information of the unfulfilled product in the offline transaction system to the user such that the user completes a transaction of the unfulfilled product in the offline transaction system.

In one embodiment, the disclosure provides a computer-readable medium, wherein the computer-readable medium stores one or more programs, and when executed by an electronic device comprising a plurality of application programs, causing the electronic device to perform the operations of: receiving a query request sent from an offline transaction system, the query request including identification information of a user; and querying, based on the identification information of the user, for an unfulfilled product in an online order of the user in the online transaction system to provide product information of the unfulfilled product in the offline transaction system to the user such that the user completes a transaction of the unfulfilled product in the offline transaction system.

According to various embodiments of the disclosure, when a user shops offline, an unfulfilled product in an online order placed by the user is inquired about, based on interactions between an offline transaction system and an online transaction system. This way, it is determined whether the unfulfilled product is available in a local product repository of the offline transaction system. If so, the product information of the unfulfilled product in the offline transaction system is provided to the user such that the user determines whether to complete a transaction of the unfulfilled product offline. Compared with the solutions of the present technologies with which offline shopping and online shopping is independent of each other, the solution provided by the disclosure effectively establishes a correlative relationship between an online order and an offline product (e.g., a product available in an offline store), thereby facilitating the user to search for, and obtain a product unfulfilled online, in an offline manner.

### BRIEF DESCRIPTION OF THE DRAWINGS

The accompanying drawings described herein are used to provide a further understanding of the disclosure and constitute a part of the disclosure. Embodiments of the disclosure and the description thereof are used to illustrate the disclosure instead of constituting improper limitations to the disclosure.

FIG. 1A is a block diagram illustrating an application scenario according to some embodiments of the disclosure.

FIG. 1B is a block diagram illustrating an application scenario according to some embodiments of the disclosure.

FIG. 2 is a flow diagram illustrating a method for processing product transactions at an offline transaction system side according to some embodiments of the disclosure.

FIG. 3 is a flow diagram illustrating a method for inquiring about an unfulfilled product of an online order in an online transaction system, according to some embodiments of the disclosure.

FIG. 4 is a flow diagram illustrating a method for inquiring about an unfulfilled product of an online order in an online transaction system and for providing the product information of the unfulfilled product in the offline transaction system to the user, according to some embodiments of the disclosure.

FIG. 5 is a flow diagram illustrating a method for processing product transactions at an online transaction system side, according to some embodiments of the disclosure.

FIG. 6 is a block diagram illustrating an apparatus for processing product transactions at an offline transaction system side, according to some embodiments of the disclosure.

FIG. 7 is a block diagram illustrating an apparatus for processing product transactions at an online transaction system side, according to some embodiments of the disclosure.

FIG. 8 is a block diagram illustrating an electronic according to some embodiments of the disclosure.

FIG. 9 is a block diagram of an electronic device according to some embodiments of the disclosure.

### DETAILED DESCRIPTION

To make the objectives, technical solutions, and advantages of the disclosure clearer, the technical solutions in the disclosure will be clearly and completely described below with reference to the embodiments and the corresponding accompanying drawings of the disclosure. The embodiments described herein are merely some rather than all of the embodiments of the disclosure. All other embodiments obtained by those skilled in the art on the basis of the embodiments of the disclosure without making significant efforts shall fall within the protection scope of the disclosure.

As described above, if a user needs to use a product purchased online, but the product is in an unfulfilled transaction state (e.g., the product has not been shipped yet, or the product is the course of being delivered), the user needs to purchase the same product from an offline store (e.g., a brick-and-mortar store, non-virtual store), in an offline manner. However, it is cumbersome and inconvenient for the user to search, among a large number of products from a large number of offline stores, for the product purchased online. Alternatively, when the user is shopping in an offline store, sometimes a product that is the same as the unfulfilled product purchased by the user online is also available in the offline store. In this scenario, if the user can purchase the unfulfilled product offline, the shopping efficiency of the user can be effectively improved. However, with present technology, because online shopping and offline shopping are independent of each other, it is difficult for the user to know in a timely manner whether a product, ordered online but not yet fulfilled, is available in an offline store, or purchase such a product while shopping offline, thereby affecting the efficiency of shopping.

According to various embodiments of the disclosure, when a user shops offline, an unfulfilled product in an online order placed by the user is inquired about, based on interactions between an offline transaction system and an online transaction system. This way, it can be determined whether the unfulfilled product is available in a local product repository of the offline transaction system. If so, the product information of the unfulfilled product in the offline transaction system is provided to the user such that the user determines whether to complete a transaction of the unfulfilled product offline. Compared with the solutions of the present technologies with which offline shopping and online shopping is independent of each other, the solution provided by the disclosure effectively establishes a correlative relationship between an online order and an offline product (e.g., a product available in an offline store), thereby facilitating the user to search for, and obtain a product unfulfilled online, in an offline manner.

As used herein, online shopping refers to shopping on the Internet. For example, online shopping includes a series of activities including, but not limited to, querying for product information on the Internet, initiating a shopping request via electronic purchase order, providing a personal check account or a credit card number, and receiving a product being delivered by mail from the manufacturer or being delivered using a home delivery service via a courier company. On the other hand, offline shopping, as used herein, refers to shopping behaviors defined relative to online shopping, including shopping behaviors in a physical store. As used herein, an unfulfilled product of an online order refers to a product ordered online but not yet in receipt by the user. Non-limiting examples include a product that has not been shipped yet, a product that is in the course of being delivered, etc.

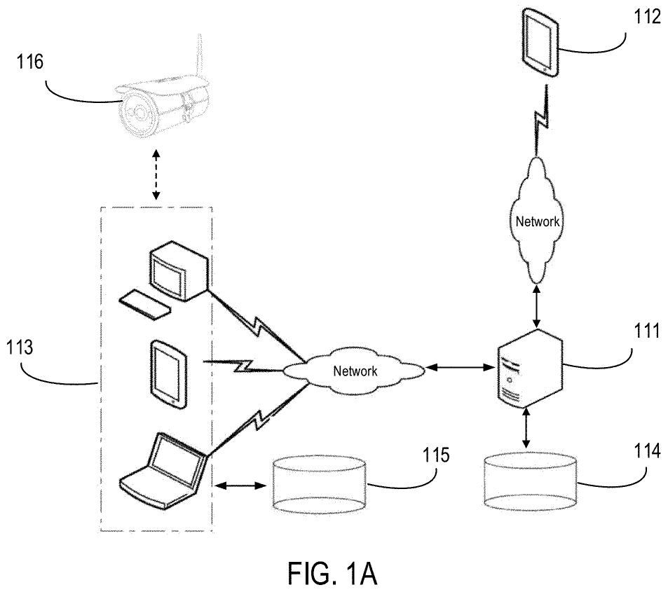

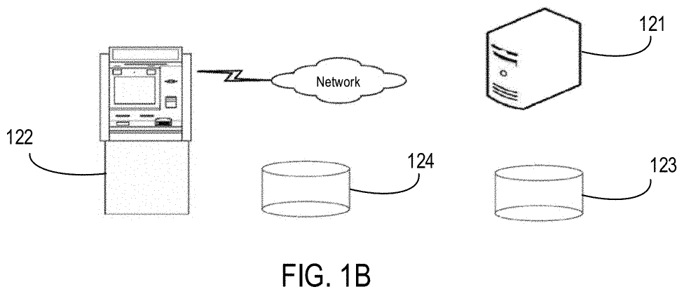

FIG. 1A is a block diagram illustrating an application scenario according to some embodiments of the disclosure. In some embodiments, and as shown in FIG. 1A, an exemplary application scenario is implemented with a system including an image acquisition apparatus 116, an offline transaction apparatus 113, a local product repository 115, an online transaction apparatus 111, an online order repository 114, and a user device 112. In this example, the image acquisition apparatus 116, the offline transaction apparatus 113, and the local product repository 115 are part of an offline transaction system, while the online transaction apparatus 111 and the online order repository 114 are part of an online transaction system.

In this example application scenario, first, the image acquisition apparatus 116 acquires identification information of a user to initiate, based on the identification information of the user, a request to the online transaction apparatus 111 to query for an unfulfilled product associated with an online order of the user.

The identification information of the user can be acquired with any suitable techniques. The following illustrates three exemplary mechanisms to obtain the identification information for the user.

In a first example, when the user enters an offline store, the image acquisition apparatus 116 acquires a facial image of the user, or image data of the facial image using a face tracking technology. Such a facial image or the image data is used as the identification information of the user. In some embodiments, the identity information of the user is further recognized based on the facial image or the image data of the facial image to be used as the identification information of the user.

In a second example, when a transaction is performed between the user device 112 and the offline transaction apparatus 113, the image acquisition apparatus 116 is triggered to acquire a facial image of the user, or image data of the facial image, using a face-tracking technology. Such a facial image or the image data is used as the identification information of the user. In some embodiments, the identity information of the user is further recognized based on the facial image or the image data of the facial image to be used as the identification information of the user.

In a third example, when a transaction is performed between the user device 112 and the offline transaction apparatus 113, an account number, a mobile phone number, a fingerprint for payment verification, and other information used in the transaction are identified as the identification information of the user.

Subsequently, in response to the query request, the online transaction apparatus 111 searches, based on the identification information of the user, the online order repository 114 for an online order of the user such that to determine an unfulfilled product in the online order of the user.

Afterward, the unfulfilled product is matched with products in the local product repository 115 associated with the offline transaction apparatus 113 to determine whether the unfulfilled product is available in an offline store corresponding to the offline transaction apparatus 113. If so, as the last step, the product information of the unfulfilled product in the local product repository 115 is provided to the user. Otherwise, the process is ended.

FIG. 1B is a block diagram illustrating an application scenario according to some embodiments of the disclosure. As shown herein, an exemplary application scenario is implemented with a system including an online transaction apparatus 121, a self-service query device 122, an online order repository 123, and a local product repository 124. In this example, the online transaction apparatus 121 and the online order repository 123 are part of an online transaction system, while the self-service query device 122 and the local product repository 124 are part of an offline transaction system.

In this exemplary application scenario, first, a user enters an offline store and operates the self-service query device 122 of the offline store to perform a query. The self-service query device 122 acquires the identification information of the user based on the operation of the user, and in turn, initiates a request to the online transaction apparatus 11 to query for an unfulfilled product in an online order of the user.

The identification information of the user can be acquired by any suitable techniques. The following illustrates two exemplary mechanisms to obtain the identification information of the user.

In a first example, during the operation of the user, based on the authorization from the user, the self-service query device 122 controls the image acquisition apparatus to acquire a facial image of the user or image data of the facial image using a face-tracking technology. Such a facial image or the image data is used as the identification information of the user. In some embodiments, the identity information of the user is further recognized based on the facial image or the image data of the facial image to be used as the identification information of the user.

In a second example, the user logs-in to the online transaction system via the self-service query device 122, which in turn designates the account information input by the user during the login as the identification information of the user.

Subsequently, in response to the query request, the online transaction apparatus 121 searches, based on the identification information of the user, the online order repository 123 for an online order associated with the user such that to determine an unfulfilled product in the online order of the user.

Afterward, the unfulfilled product is matched with products in the local product repository 124 to determine whether the unfulfilled product is available in the offline store. If so, the product information of the unfulfilled product in the local product repository 124 is provided to the user. Otherwise, the process is ended.

In the above two exemplary application scenarios, the online transaction apparatus can include a back-end server corresponding to a client used by the user for online shopping. Non-limiting exemplary functions of the back-end server include: managing local product repositories of offline stores connected to the back-end server, online orders from clients, and so on. The offline transaction apparatus can include an all-in-one cash register. The online order repository stores online orders corresponding to users; while the online product repository stores lists of offline stores and products sold therein.

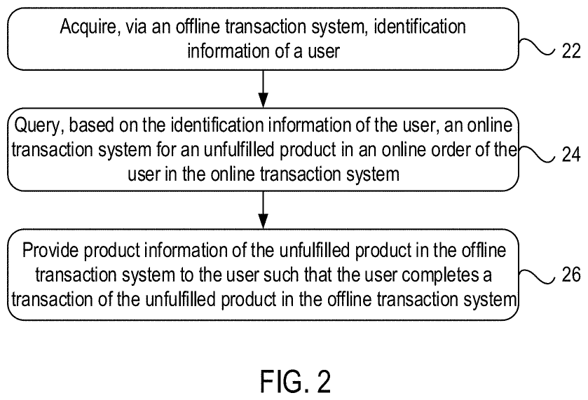

FIG. 2 is a flow diagram illustrating a method for processing product transactions according to some embodiments of the disclosure. In some embodiments, the method is executed by the offline transaction apparatus 113 of FIG. 1A, or by the self-service query device 122 in FIG. 1B. In some embodiments and as shown in FIG. 2, the method includes the following steps.

Step 22: acquire identification information of a user.

In some embodiments, a facial image of the user located in an image acquisition area of the offline transaction system is acquired to determine the identification information of the user. In one embodiment, when the user is in a predetermined image acquisition area of the offline store, the offline transaction system automatically acquires a facial image of the user. Such a facial image is used as the identification information of the user. In some embodiments, the image data of the facial image is further processed to determine the identification information of the user. In some embodiments, the identity information of the user is further determined based on the facial image or the image data of the facial image and used as the identification information of the user.

In some embodiments, when a transaction is performed with the client of the user, the account information of the user is acquired and used as the identification information of the user. In one example, when the user enters a payment code to make a payment, the offline transaction system scans to acquire the payment code of the user. Such a payment code is used as the identification information of the user. In some embodiments, the account information of the user corresponding to the payment code is acquired and used as the identification information of the user.

In some embodiments, a facial image input by the user via a self-service query device of the offline transaction system is acquired to determine the identification information of the user. In some embodiments, the account information input by the user via the self-service query terminal of the offline transaction system is acquired and used as the identification information of the user. In one embodiment, the user operates the self-service query device of the offline store to query whether the product already purchased online is available in the store. For instance, the user can input the name of the product purchased online and select the product information (e.g., the model, the flavor of the product) to query whether the product purchased online is available in the store. In another embodiment, the user can log in to the online transaction system via the self-service query device by, for example, face recognition based login, account password-based login. As such, the facial image or the account information input by the user during the login can be acquired to determine the identification information of the user. In some embodiments, without the need to log in to the online transaction system, the user instead directly authorizes the self-service query device to perform an automatic query, with which the self-service query device automatically acquires a facial image of the user based on the authorization to determine the identification information of the user.

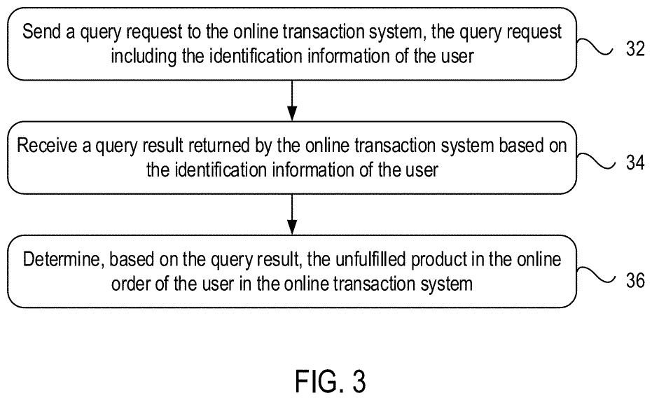

Step 24: query, based on the identification information of the user, an online transaction system for an unfulfilled product associated with an online order of the user in the online transaction system. In one embodiment, step 24 includes the methods described with reference to FIG. 3.

FIG. 3 is a flow diagram illustrating a method for querying for an unfulfilled product associated with an online order of the user in an online transaction system, according to some embodiments of the disclosure. In some embodiments and as shown in FIG. 3, the method includes the following steps.

Step 32: send a query request to the online transaction system, the query request including the identification information of the user.

Step 34: receive a query result returned by the online transaction system based on the identification information of the user.

Step 36: determine, based on the query result, the unfulfilled product associated with the online order of the user in the online transaction system.

In some embodiments, after the query request is sent to the online transaction system, the online transaction system queries, in response to the query request, the online order repository based on the identification information of the user. As such, the online transaction system searches the online order(s) of the user to determine the unfulfilled product in the online order(s). In turn, the online transaction system includes the product information of the unfulfilled product in the query result for returning to the offline transaction system. In this way, the offline transaction system can determine, based on the query result, the unfulfilled product in the online order(s).

By way of non-limiting examples, the product information of the unfulfilled product includes a product name, a product package appearance, a product model, and the like.

Now referring back to FIG. 2, the method further includes step 26: provide the product information of the unfulfilled product in the offline transaction system to the user such that the user completes a transaction of the unfulfilled product in the offline transaction system.

By way of non-limiting examples, the product information of the unfulfilled product further includes the placement position of the product in the offline store, the price of the product, and the like.

In some embodiments, upon determining that the unfulfilled product is available in the local product repository of the offline transaction system, the product information of the unfulfilled product in the local product repository is provided to the user. In one embodiment, the offline transaction system matches, based on the product information (e.g., the product name, the product package appearance, etc.), the unfulfilled product with products in the local product repository. This way, it is determined whether the unfulfilled product or a similar product matching the unfulfilled product in a degree meets a predetermined threshold is available in the local product repository. If so, the product information of the determined product in the offline transaction system is provided to the user.

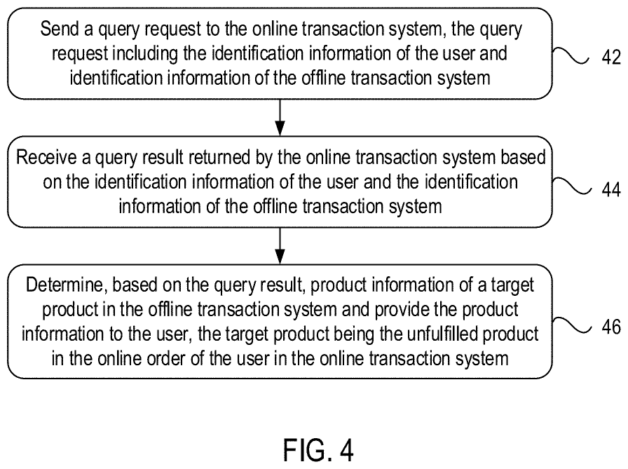

In some embodiments, step 24 and step 26 include the methods described with reference to FIG. 4.

FIG. 4 is a flow diagram illustrating a method for querying for an unfulfilled product associated with an online order of the user in an online transaction system, as well as for providing the product information of the unfulfilled product in the offline transaction system to the user, according to some embodiments of the disclosure. In some embodiments and as shown in FIG. 4, the method includes the following steps.

Step 42: send a query request to the online transaction system, the query request including the identification information of the user and identification information of the offline transaction system.

Step 44: receive a query result returned by the online transaction system based on the identification information of the user and the identification information of the offline transaction system.

Step 46: determine, based on the query result, the product information of a target product in the offline transaction system, and provide the product information to the user, the target product being the unfulfilled product in the online order of the user in the online transaction system.

In some embodiments, after the offline transaction system sends the query request to the online transaction system, the online transaction system searches, based on the identification information of the user, the online order repository for the unfulfilled product in the online order(s) of the user. The online transaction system further acquires, based on the identification information of the offline transaction system, products in the local product repository of the offline transaction system. Next, the online transaction system matches, based on the product information of the unfulfilled product, the unfulfilled product with the products in the local product repository to determine whether the unfulfilled product or a similar product matching the unfulfilled product with a degree meets a predetermined threshold is available in the local product repository. If so, the product information of the determined product in the offline transaction system is provided to the offline transaction system, which in turn provides the product information to the user.

In some embodiments, providing the product information to the user in step 26 includes displaying the product information of the unfulfilled product to the user via a display screen of the offline transaction system.

For example, when the user uses the self-service query device to perform a query operation, the product information of the unfulfilled product can be displayed on a display screen of the self-service query device.

In some embodiments, providing the product information to the user includes sending the product information of the unfulfilled product to a client of the user via the online transaction system for displaying to the user.

For example, the offline transaction system sends a prompt request to the online transaction system, the prompt request including the product information of the unfulfilled product in the offline transaction system. This way, the online transaction system sends the product information to the client of the user in response to the prompt request for displaying to the user by the client.

In some embodiments, providing the product information to the user includes sending the product information of the unfulfilled product to the client of the user via the offline transaction system for displaying to the user.

In one example, the product information displayed to the user may include the text “Your online purchase of ‘cat food,’ which has not been shipped yet is available in the daily product section of this physical store, and the price is 19 dollars.”

In some embodiments, for the ease of searches and purchases by the user, when the user determines to search for the unfulfilled product offline, the offline transaction system also invokes, based on the placement position of the unfulfilled product in the store recorded in the local product repository, an external device to mark the unfulfilled product. For example, lighting is controlled to project on a region in which the unfulfilled product is located.

In some embodiments, to facilitate the user to check-out the unfulfilled product offline such that the user can obtain the unfulfilled product in a timely manner and without duplicated purchases of the same product online and offline, embodiments of the disclosure further provide a method for checking-out the unfulfilled product offline. In some embodiment, such a method includes the following steps.

Step S1: acquire a difference between a transaction amount of the unfulfilled product at the online transaction system and a transaction amount of the unfulfilled product at the offline transaction system; and provide the difference in transaction amount to the user such that the user completes the transaction based on the difference.

In some embodiments, based on step 36, when the online transaction system searches the online order repository for the unfulfilled product in the online order of the user, the online transaction system also acquires an online selling price of the unfulfilled product in the online transaction system. The online transaction system includes the online selling price in the query result returned to the offline transaction system. The offline transaction system determines the online selling price of the unfulfilled product based on the query result and then queries for an offline selling price of the unfulfilled product in the offline transaction system. This way, a transaction amount difference between the online selling price and the offline selling price for the unfulfilled product is computed.

In some embodiments, based on step 46, when the online transaction system searches the online order repository for the unfulfilled product in the online order of the user, the online transaction system also acquires an online selling price of the unfulfilled product, then determines whether the unfulfilled product or a similar product matching the unfulfilled product with a degree meeting a predetermined threshold is available in the local product repository. If so, an offline selling price of the unfulfilled product is determined to calculate a transaction amount difference between the online selling price and the offline selling price of the unfulfilled product. The transaction amount difference is included in the query result for returning to the offline transaction system such that the offline transaction system determines, based on the query result, the transaction amount difference between the online selling price and the offline selling price of the unfulfilled product.

In some embodiments, the offline transaction system displays the transaction amount difference to the user or a cashier such that the user chooses whether to complete a transaction of the unfulfilled product in the offline transaction system. If so, the process proceeds to s step S2; otherwise, the process is ended.

Step S2: acquire an authorization instruction from the user, the authorization instruction being used to indicate that the user authorizes the transaction.

In some embodiments, firstly, an authorization verification method selected by the user is determined. In some examples, such an authorization verification method includes fingerprint-based authorization, quick response (QR) code-based authorization, and the like. Next, the cashier operates the offline transaction system to navigate to a corresponding authorization verification interface for the user to input authorization information.

For example, in the case where the user selects the fingerprint-based authorization verification method, the cashier guides the user to input a fingerprint via a fingerprint acquisition apparatus of the offline transaction system to complete the authorization. If the user selects the QR code-based authorization verification method, the offline transaction system generates a QR code for authorization verification, and the user operates the client to scan the QR code. After the confirmation by the user on the client, an authorization instruction is returned to the offline transaction system.

Step S3: send, based on the authorization instruction and the transaction amount difference, a request for conducting the transaction to the online transaction system.

In some embodiments, the offline transaction system sends a transaction request to the online transaction system based on the authorization instruction. The transaction request is used to request a transaction with the client of the user based on the transaction amount difference.

If the online selling price is higher than or equal to the offline selling price, the online transaction system responds to the transaction request to complete the transaction and returns a notification message to indicate the completion of the transaction. This way, the user can fetch the unfulfilled product at the offline store, and the process is ended.

If the online selling price is lower than the offline selling price, the client pays the transaction amount difference to the offline transaction system. Upon determining that the client has paid the transaction amount difference, the online transaction system returns, to the offline transaction system, a notification message indicating the completion of the transaction. This way, the user is also authorized to check-out the unfulfilled product offline, and the process is ended.

In some embodiments, to facilitate the user to query a real-time status of the online order, after the completion of the offline transaction of the unfulfilled product, embodiments of the disclosure further provide a method for changing the status of the online order. In some embodiments, the method includes a step of sending an order status modification instruction to the online transaction system such that the online transaction system updates an order status of the online order of the unfulfilled product.

According to various embodiments of the disclosure, when a user shops offline, an unfulfilled product in an online order placed by the user is inquired about, based on interactions between an offline transaction system and an online transaction system. This way, it is determined whether the unfulfilled product is available in a local product repository of the offline transaction system. If so, the product information of the unfulfilled product in the offline transaction system is provided to the user such that the user determines whether to complete a transaction of the unfulfilled product offline. Compared with the solutions of the present technologies with which offline shopping and online shopping is independent of each other, the solution provided by the disclosure effectively establishes a correlative relationship between an online order and an offline product (e.g., a product available in an offline store), thereby facilitating the user to search for, and obtain a product unfulfilled online, in an offline manner.

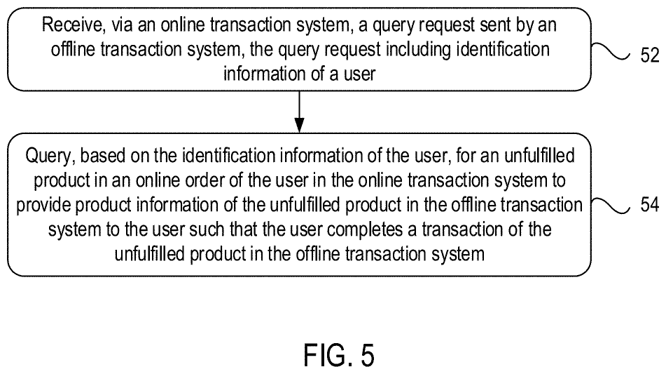

FIG. 5 is a flow diagram illustrating a method for processing product transactions at an online transaction system side, according to some embodiments of the disclosure. In some embodiments, the method is executed by the online transaction apparatus 111 of FIG. 1A, or the online transaction apparatus 121 in FIG. 1B. In some embodiments and as shown in FIG. 5, the method includes the following steps.

Step 52: receive, via an online transaction system, a query request sent by an offline transaction system, the query request including identification information of a user.

Step 54: query, based on the identification information of the user, for an unfulfilled product in an online order of the user in the online transaction system to provide the product information of the unfulfilled product in the offline transaction system to the user such that the user completes a transaction of the unfulfilled product in the offline transaction system.

Details of step 52 and step 54 that are substantially similar to the embodiments illustrated with connection to embodiments of the offline transaction system side would not be repeated herein.

In some embodiments, the method further includes sending the information of the unfulfilled product to the offline transaction system to query whether the unfulfilled product is available in a local product repository of the offline transaction system.

In some embodiments, the method further includes sending the product information of the unfulfilled product to a client of the user for displaying to the user.

According to various embodiments of the disclosure, when a user shops offline, an unfulfilled product in an online order placed by the user is inquired about, based on interactions between an offline transaction system and an online transaction system. This way, it is determined whether the unfulfilled product is available in a local product repository of the offline transaction system. If so, the product information of the unfulfilled product in the offline transaction system is provided to the user such that the user determines whether to complete a transaction of the unfulfilled product offline. Compared with the solutions of the present technologies with which offline shopping and online shopping is independent of each other, the solution provided by the disclosure effectively establishes a correlative relationship between an online order and an offline product (e.g., a product available in an offline store), thereby facilitating the user to search for, and obtain a product unfulfilled online, in an offline manner.

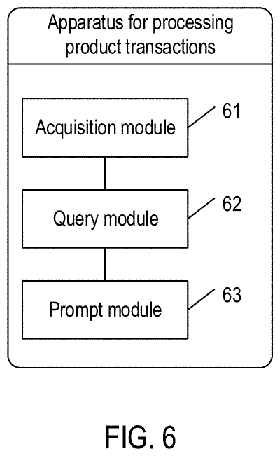

FIG. 6 is a block diagram illustrating an apparatus for processing product transactions at an offline transaction system side, according to some embodiments of the disclosure. In some embodiments and as shown in FIG. 6, the apparatus includes an acquisition module (61), a query module (62), and a prompt module (63).

The acquisition module (61) is configured to acquire identification information of a user.

The query module (62) is configured to query, based on the identification information of the user, an online transaction system for an unfulfilled product in an online order associated with the user in the online transaction system.

The prompt module (63) is configured to provide the product information of the unfulfilled product in the offline transaction system to the user such that the user completes a transaction of the unfulfilled product in the offline transaction system.

In some embodiments, the query module (62) is further configured to: send a query request to the online transaction system, the query request including the identification information of the user; receive a query result returned by the online transaction system based on the identification information of the user; and determine, based on the query result, the unfulfilled product in the online order associated with the user in the online transaction system.

In some embodiments, the prompt module (63) is further configured to: upon determining that the unfulfilled product is available in a local product repository of the offline transaction system, provide the product information of the unfulfilled product in the local product repository to the user.

In some embodiments, the prompt module (63) is further configured to display, via a display screen of the offline transaction system, the product information of the unfulfilled product to the user. In some embodiments, the prompt module (63) is further configured to: send, via the online transaction system, the product information of the unfulfilled product to a client of the user for displaying to the user.

In some embodiments, the acquisition module (61) is further configured to: acquire a transaction amount difference between the unfulfilled product in the online transaction system and the unfulfilled product in the offline transaction system; and provide the transaction amount difference to the user such that the user completes the transaction based on the transaction amount difference.

In some embodiments, the apparatus further includes a transaction module configured to: acquire an authorization instruction from the user, the authorization instruction being used to indicate that the user authorizes the transaction; and initiate to the online transaction system based on the authorization instruction and the transaction amount difference, a request for performing the transaction.

In some embodiments, the apparatus further includes an order status modification module configured to send an order status modification instruction to the online transaction system such that the online transaction system updates an order status of the online order of the unfulfilled product.

In some embodiments, the acquisition module (61) is further configured to acquire a facial image of the user located in an image acquisition area of the offline transaction system so as to determine the identification information of the user. In some embodiments, the acquisition module (61) is further configured to: acquire the account information of the user during a transaction with the client of the user; and use the account information as the identification information of the user. In some embodiments, the acquisition module (61) is further configured to acquire a facial image input by the user via a self-service query device of the offline transaction system to determine the identification information of the user. In some embodiments, the acquisition module (61) is further configured to acquire the account information input by the user via a self-service query device of the offline transaction system; and use the account information as the identification information of the user.

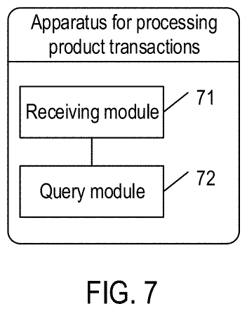

FIG. 7 is a block diagram illustrating an apparatus for processing product transactions at an online transaction system side, according to some embodiments of the disclosure. In some embodiments and as shown in FIG. 7, the apparatus includes a receiving module (71) and a query module (72).

The receiving module (71) is configured to receive a query request sent by an offline transaction system, the query request including identification information of a user.

The query module (72) is configured to query, based on the identification information of the user, for an unfulfilled product in an online order associated with the user in the online transaction system to provide the product information of the unfulfilled product in the offline transaction system to the user such that the user completes a transaction of the unfulfilled product in the offline transaction system.

In some embodiments, the apparatus further includes a first sending module configured to send the information of the unfulfilled product to the offline transaction system to query whether the unfulfilled product is available in a local product repository of the offline transaction system.

In some embodiments, the apparatus further includes a second sending module configured to send the product information of the unfulfilled product to a client of the user for displaying to the user.

According to various embodiments of the disclosure, when a user shops offline, an unfulfilled product in an online order placed by the user is inquired about, based on interactions between an offline transaction system and an online transaction system. This way, it is determined whether the unfulfilled product is available in a local product repository of the offline transaction system. If so, the product information of the unfulfilled product in the offline transaction system is provided to the user such that the user determines whether to complete a transaction of the unfulfilled product offline. Compared with the solutions of the present technologies with which offline shopping and online shopping is independent of each other, the solution provided by the disclosure effectively establishes a correlative relationship between an online order and an offline product (e.g., a product available in an offline store), thereby facilitating the user to search for, and obtain a product unfulfilled online, in an offline manner.

Details of the apparatus embodiments that are substantially similar to the above-described embodiments of methods are not repeated herein.

It should be noted that, in the above-described embodiments, the components of the apparatus are divided logically based on functions thereof to be implemented. However, it should be understood that embodiments of the disclosure is not limited to the examples, and the components may be sub-divided or recombined in any suitable manner based on requirements.

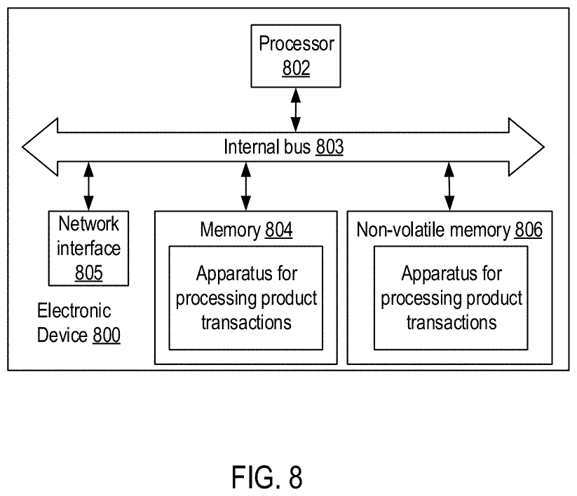

FIG. 8 is a block diagram illustrating an electronic device according to some embodiments of the disclosure. In some embodiments and as shown in FIG. 8, the electronic device (800) includes a processor (802), an internal bus (803), a network interface (805), a memory (804), and a non-volatile memory (806). In some embodiments, the electronic device (800) also includes the hardware required by other services. The processor (802) reads a corresponding computer program into the memory (804) from the non-volatile memory (806) and then runs the computer program to form, on a logical level, an apparatus for processing product transactions. In some embodiments, in addition to the implementation in software, the disclosure does not exclude other implementations such as the use of a logic device or a combination of software and hardware. That is, the entity executing the processing flows are not limited to logical units and may also be hardware or logic devices.

The network interface (805), the processor (802), and the memory (804) can be connected to each other via a bus system (803). The bus may be an Industry Standard Architecture (ISA) bus, a Peripheral Component Interconnect (PCI) bus, or an Extended Industry Standard Architecture (EISA) bus, etc. The bus may be divided into an address bus, a data bus, a control bus, etc. For ease of illustration, only one double-headed arrow is shown in FIG. 8. However, it is not indicated that only one bus or only one type of bus is provided.

Memory (804) is used to store a program. In some embodiments, the program includes program code, which includes computer operation instructions. The memory (804) may include a read-only memory and a random access memory and provides instructions and data to the processor (802). The memory (804) may include a high-speed Random Access Memory (RAM) and may also include non-volatile memory, such as at least one disc memory.

The processor (802) is configured to execute the program stored in the memory (804) to perform the operations of acquiring identification information of a user; querying, based on the identification information of the user, an online transaction system for an unfulfilled product in an online order associated with the user in the online transaction system; and providing product information of the unfulfilled product in the offline transaction system to the user such that the user completes a transaction of the unfulfilled product in the offline transaction system.

In some embodiments, a method executed by the apparatus for processing product transactions above-described with connection to the embodiment of FIG. 6, or a method executed by a master node can be performed by the processor (802) or can be implemented by the processor (802). The processor (802) may include an integrated circuit chip and is capable of processing signals. In an implementation, steps in the foregoing methods can be implemented via an integrated logic circuit of hardware in the processor or via instructions in the form of software. The processor (802) may be a general-purpose processor, including a Central Processing Unit (CPU), a Network Processor (NP), etc. The processor may also be a Digital Signal Processor (DSP), an Application Specific Integrated Circuit (ASIC), a Field-Programmable Gate Array (FPGA), or other programmable logic devices, discrete gates or transistor logic devices, and discrete hardware components. All of the methods, the steps, and the logical block diagrams disclosed in the embodiments of the disclosure can be implemented or performed by the processor. The general-purpose processor may be a microprocessor, or the processor may be any conventional processor or the like. Steps of the methods disclosed with reference to the embodiments of the disclosure may be directly executed and accomplished by a hardware decoding processor or may be executed and accomplished by a combination of hardware and software modules in the decoding processor. The software module may be located in a mature storage medium in the art, such as a random access memory, a flash memory, a read-only memory, a programmable read-only memory, an electrically-erasable programmable memory, or a register. The storage medium is located in the memory. The processor reads information in the memory and completes the steps in the foregoing methods in combination with the hardware of the processor.

In some embodiments, the apparatus for processing product transactions can further execute the methods illustrated with connection to FIGS. 2-4 and implement methods executed by the master node.

Embodiments of the disclosure further provide a computer-readable storage medium. In some embodiments, the computer-readable storage medium stores one or more programs when executed by an electronic device, including a plurality of application programs, causing the electronic device to execute the methods for processing product transactions on the offline transaction system side.

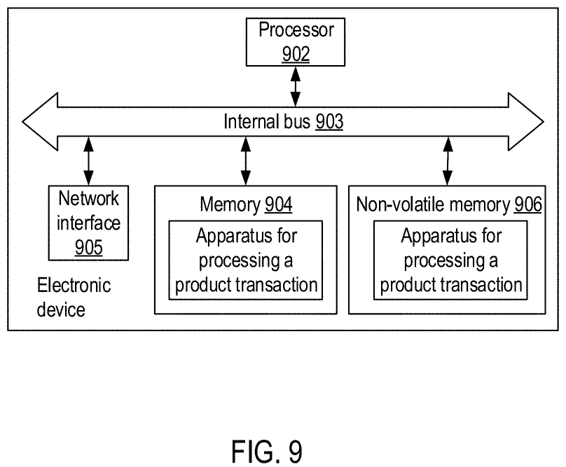

FIG. 9 is a block diagram of an electronic device according to some embodiments of the disclosure. In some embodiments and as shown in FIG. 9, the electronic device includes a processor (902), an internal bus (903), a network interface (905), a memory (904), and a non-volatile memory (906). In some embodiments, the electronic device also includes the hardware required by other services. The processor (902) reads a corresponding computer program into the memory (904) from the non-volatile memory (906) and then runs the computer program to form, on a logical level, an apparatus for processing product transactions. In some embodiments, in addition to the implementation in software, the disclosure does not exclude other implementations such as the use of a logic device or a combination of software and hardware. That is, the entities executing the following processing flows are not limited to logical units and may also be hardware or logic devices.

The network interface (905), the processor (902), and the memory (904) can be connected to each other via a bus system (903). The bus may be an Industry Standard Architecture (ISA) bus, a Peripheral Component Interconnect (PCI) bus, or an Extended Industry Standard Architecture (EISA) bus, etc. The bus may be divided into an address bus, a data bus, a control bus, etc. For ease of illustration, only one double-headed arrow is shown in FIG. 9. However, it is not indicated that only one bus or only one type of bus is provided.

Memory (904) is used to store a program; the program may include program code, which includes computer operation instructions. The memory (904) may include a read-only memory and a random access memory and provides instructions and data to the processor (902). The memory may include a high-speed Random Access Memory (RAM) and may also include non-volatile memory, such as at least one disc memory.

The processor (902) is configured to execute the program stored in the memory (904) to perform the operations of receiving a query request sent by an offline transaction system, the query request including identification information of a user; and querying, based on the identification information of the user, for an unfulfilled product in an online order associated with the user in the online transaction system to provide product information of the unfulfilled product in the offline transaction system to the user such that the user completes a transaction of the unfulfilled product in the offline transaction system.

In some embodiments, a method executed by the apparatus for processing product transactions above-described with connection to the embodiment of FIG. 7, or executed by a master node can be performed at the processor or can be implemented by the processor. The processor may include an integrated circuit chip and is capable of processing signals. In an implementation, steps in the foregoing methods can be implemented via an integrated logic circuit of hardware in the processor or via instructions in the form of software. The processor may be a general-purpose processor, including a Central Processing Unit (CPU), a Network Processor (NP), etc. The processor may also be a Digital Signal Processor (DSP), an Application Specific Integrated Circuit (ASIC), a Field-Programmable Gate Array (FPGA), or other programmable logic devices, discrete gates or transistor logic devices, and discrete hardware components. All of the methods, the steps, and the logical block diagrams disclosed in the embodiments of the disclosure can be implemented or performed by the processor. The general-purpose processor may be a microprocessor, or the processor may be any conventional processor or the like. Steps of the methods disclosed with reference to the embodiments of the disclosure may be directly executed and accomplished by a hardware decoding processor or may be executed and accomplished by a combination of hardware and software modules in the decoding processor. The software module may be located in a mature storage medium in the art, such as a random access memory, a flash memory, a read-only memory, a programmable read-only memory, an electrically-erasable programmable memory, or a register. The storage medium is located in the memory. The processor reads information in the memory and completes the steps in the foregoing methods in combination with the hardware of the processor.

In some embodiments, the apparatus for processing product transactions can further execute the method illustrated with connection to FIG. 5, and implement the method executed by the master node.

Embodiments of the disclosure further provide a computer-readable storage medium. The computer-readable storage medium stores one or more programs, when executed by an electronic device including a plurality of application programs, causing the electronic device to execute the method for processing product transactions on the online transaction system side.

The embodiments in the present specification are described in a progressive manner, and for identical or similar parts between different embodiments, reference may be made to each other so that each of the embodiments focuses on differences from other embodiments. In particular, because the system embodiments are substantially similar to the method embodiments, the description for the system embodiments is relatively concise, and reference can be made to the description of the method embodiments for related parts.

The specific embodiments in the description of the disclosure have been described above. Other embodiments fall within the scope of the appended claims. In some cases, the actions or steps recited in the claims may be performed in a different order than in the embodiments and still achieve the desired results. In addition, the processes depicted in the drawings do not necessarily require the illustrated particular order or consecutive order to achieve the desired results. In some implementations, multitask processing and parallel processing are also possible or favorable.

Those skilled in the art should understand that the embodiments of the present invention may be provided as a method, a system, or a computer program product. Therefore, the present invention may use the form of a full hardware embodiment, a full software embodiment, or an embodiment combining software and hardware. Moreover, the present invention may use the form of a computer program product implemented on one or a plurality of computer-usable storage media (including, but not limited to, a magnetic disk memory, a CD-ROM, an optical memory, etc.) containing computer-usable program code therein.

The present invention is described with reference to the flowcharts and/or block diagrams of the method, the device (system), and the computer program product based on the embodiments in the description of the disclosure. It should be understood that each procedure and/or block in the flowcharts and/or block diagrams, and a combination of procedures and/or blocks in the flowcharts and/or block diagrams may be implemented with computer program instructions. These computer program instructions may be provided to a processor of a general-purpose computer, a special-purpose computer, an embedded processor, or any other programmable data processing device to produce a machine, so that instructions executed by the processor of the computer or other programmable data processing device generate means for implementing a specified function in one or a plurality of procedures in the flowcharts and/or one or a plurality of blocks in the block diagrams.

These computer program instructions may also be stored in a computer-readable memory that can direct a computer or any other programmable data processing device to operate in a particular manner, so that the instructions stored in the computer-readable memory produce an article of manufacture including instruction means, the instruction means implementing a specified function in one or a plurality of procedures in the flowcharts and/or one or a plurality of blocks in the block diagrams.

These computer program instructions may also be loaded onto a computer or any other programmable data processing device so that a series of operational steps are performed on the computer or other programmable device to produce computer-implemented processing, and thus the instructions executed on the computer or other programmable device provide the steps for implementing a specified function in one or a plurality of procedures in the flowcharts and/or one or a plurality of blocks in the block diagrams.

In a typical configuration, the computing device includes one or a plurality of processors (CPUs), input/output interfaces, network interfaces, and memories.

The memory may include a computer-readable medium in the form of a non-permanent memory, a Random Access Memory (RAM) and/or non-volatile memory or the like, such as a Read-Only Memory (ROM) or a flash memory (flash RAM). The memory is an example of the computer-readable medium.

The computer-readable medium includes permanent and non-permanent, movable and non-movable media that can achieve information storage by means of any methods or techniques. The information may be a computer-readable instruction, a data structure, a module of a program, or other data. Examples of a storage medium of a computer include, but are not limited to, a Phase Change Memory (PRAM), a Static Random Access Memory (SRAM), a Dynamic Random Access Memory (DRAM), other types of Random Access Memories (RAMs), a Read-Only Memory (ROM), an Electrically Erasable Programmable Read-Only Memory (EEPROM), a flash memory or other memory technologies, a Compact Disk Read-Only Memory (CD-ROM), a Digital Versatile Disc (DVD) or other optical storages, a cassette tape, a magnetic tape/magnetic disk storage or other magnetic storage devices, or any other non-transmission medium, and can be used to store information accessible by a computing device. Based on the definitions herein, the computer-readable medium does not include transitory computer-readable media (transitory media), such as a modulated data signal and a carrier wave.

It should further be noted that the term “include,” “comprise,” or any other variation thereof is intended to encompass a non-exclusive inclusion, so that a process, method, commodity, or device that includes a series of elements includes not only those elements but also other elements not explicitly listed, or elements that are inherent to such a process, method, commodity, or device. The element defined by the statement “including one . . . ,” without further limitation, does not preclude the presence of additional identical elements in the process, method, commodity, or device that includes the element.

Those skilled in the art should understand that embodiments of the disclosure may be provided as a method, a system, or a computer program product. Therefore, the disclosure may use the form of a full hardware embodiment, a full software embodiment, or an embodiment combining software and hardware. Moreover, the disclosure may use the form of a computer program product implemented on one or a plurality of computer-usable storage media (including, but not limited to, a magnetic disk memory, a CD-ROM, an optical memory, and so on) containing computer-usable program code therein.

The above descriptions are merely the embodiments of the disclosure, and are not intended to limit the disclosure. For those skilled in the art, the disclosure may have various alterations and changes. Any modifications, equivalent substitutions, improvements and the like made within the spirit and principle of the disclosure shall fall within the scope of the claims of the disclosure.

1-17. (canceled)

18. A method comprising:
acquiring, via an offline transaction system, identification information of a user;
querying an online transaction system for an unfulfilled product based on the identification information of the user, the unfulfilled product associated with an online order of the user stored by the online transaction system;
providing product information of the unfulfilled product in the offline transaction system to the user; and
enabling the user to complete a transaction of the unfulfilled product in the offline transaction system.

19. The method of claim 18, the querying an online transaction system for an unfulfilled product comprising:
sending a query request to the online transaction system, the query request including the identification information of the user;
receiving a query result returned by the online transaction system based on the identification information of the user; and
determining, based on the query result, the unfulfilled product associated with the online order of the user in the online transaction system.

20. The method of claim 18, the providing product information of the unfulfilled product in the offline transaction system to the user comprising:
determining whether the unfulfilled product is available in a local product repository of the offline transaction system; and
in response to determining that the unfulfilled product is available in the local product repository of the offline transaction system, providing the product information of the unfulfilled product in the local product repository to the user.

21. The method of claim 18, the providing product information of the unfulfilled product in the offline transaction system to the user comprising at least one of:
displaying, via a display screen of the offline transaction system, the product information of the unfulfilled product to the user; and
sending, via the online transaction system, the product information of the unfulfilled product to a client of the user for displaying to the user.

22. The method of claim 18, further comprising:
acquiring a difference between a first transaction amount of the unfulfilled product in the online transaction system and a second transaction amount of the unfulfilled product in the offline transaction system; and
providing the difference to the user such that the user completes the transaction based on the difference.

23. The method of claim 22, further comprising:
acquiring an authorization instruction from the user, the authorization instruction being used to indicate that the user authorizes the transaction; and
transmitting, based on the authorization instruction and the difference, a request to the online transaction system for performing the transaction.

24. The method of claim 23, further comprising:
sending an order status modification instruction to the online transaction system; and
causing the online transaction system to update an order status of the online order of the unfulfilled product based on the order status modification instruction.

25. The method of claim 18, the acquiring identification information of a user comprising at least one of:
acquiring, via the offline transaction system, a facial image of the user to determine the identification information of the user;
acquiring, via a transaction between the offline transaction system and a client of the user, account information of the user, the account information designated as the identification information of the user;
acquiring, via a self-service query device of the offline transaction system, a facial image input by the user to determine the identification information of the user; and
acquiring, via the self-service query device of the offline transaction system, account information input by the user, the account information designated as the identification information of the user.

26. An apparatus comprising:
a processor; and
a storage medium for tangibly storing thereon program logic for execution by the processor, the stored program logic comprising:
logic, executed by the processor, for acquiring, via an offline transaction system, identification information of a user,
logic, executed by the processor, for querying an online transaction system for an unfulfilled product based on the identification information of the user, the unfulfilled product associated with an online order of the user stored in by the online transaction system,
logic, executed by the processor, for providing product information of the unfulfilled product in the offline transaction system to the user, and
logic, executed by the processor, for enabling the user to complete a transaction of the unfulfilled product in the offline transaction system.

27. The apparatus of claim 26, the logic for querying an online transaction system for an unfulfilled product comprising:
logic, executed by the processor, for sending a query request to the online transaction system, the query request including the identification information of the user,
logic, executed by the processor, for receiving a query result returned by the online transaction system based on the identification information of the user, and
logic, executed by the processor, for determining, based on the query result, the unfulfilled product associated with the online order of the user in the online transaction system.

28. The apparatus of claim 26, the logic for providing product information of the unfulfilled product in the offline transaction system to the user comprising:
logic, executed by the processor, for determining whether the unfulfilled product is available in a local product repository of the offline transaction system, and
logic, executed by the processor, for, in response to determining that the unfulfilled product is available in the local product repository of the offline transaction system, providing the product information of the unfulfilled product in the local product repository to the user.

29. The apparatus of claim 26, the logic for providing product information of the unfulfilled product in the offline transaction system to the user comprising at least one of:
logic, executed by the processor, for displaying, via a display screen of the offline transaction system, the product information of the unfulfilled product to the user, and
logic, executed by the processor, for sending, via the online transaction system, the product information of the unfulfilled product to a client of the user for displaying to the user.

30. The apparatus of claim 26, the stored program logic further comprising:
logic, executed by the processor, for acquiring a difference between a first transaction amount of the unfulfilled product in the online transaction system and a second transaction amount of the unfulfilled product in the offline transaction system, and
logic, executed by the processor, for providing the difference to the user such that the user completes the transaction based on the difference.

31. The apparatus of claim 30, the stored program logic further comprising:
logic, executed by the processor, for acquiring an authorization instruction from the user, the authorization instruction being used to indicate that the user authorizes the transaction, and
logic, executed by the processor, for transmitting, based on the authorization instruction and the difference, a request to the online transaction system for performing the transaction.

32. The apparatus of claim 31, the stored program logic further comprising:
logic, executed by the processor, for sending an order status modification instruction to the online transaction system, and
logic, executed by the processor, for causing the online transaction system to update an order status of the online order of the unfulfilled product based on the order status modification instruction.

33. The apparatus of claim 26, the logic for acquiring identification information of a user comprising at least one of:
logic, executed by the processor, for acquiring, via the offline transaction system, a facial image of the user to determine the identification information of the user,
logic, executed by the processor, for acquiring, via a transaction between the offline transaction system and a client of the user, account information of the user, the account information designated as the identification information of the user,
logic, executed by the processor, for acquiring, via a self-service query device of the offline transaction system, a facial image input by the user to determine the identification information of the user, and
logic, executed by the processor, for acquiring, via the self-service query device of the offline transaction system, account information input by the user, the account information designated as the identification information of the user.

34. A non-transitory computer-readable storage medium for tangibly storing computer program instructions capable of being executed by a computer processor, the computer program instructions defining the steps of:
acquiring, via an offline transaction system, identification information of a user;
querying an online transaction system for an unfulfilled product based on the identification information of the user, the unfulfilled product associated with an online order of the user stored by the online transaction system;
providing product information of the unfulfilled product in the offline transaction system to the user; and
enabling the user to complete a transaction of the unfulfilled product in the offline transaction system.

35. The computer-readable storage medium of claim 34, the querying an online transaction system for an unfulfilled product comprising:
sending a query request to the online transaction system, the query request including the identification information of the user;
receiving a query result returned by the online transaction system based on the identification information of the user; and
determining, based on the query result, the unfulfilled product associated with the online order of the user in the online transaction system.

36. The computer-readable storage medium of claim 34, the providing product information of the unfulfilled product in the offline transaction system to the user comprising:
determining whether the unfulfilled product is available in a local product repository of the offline transaction system; and
in response to determining that the unfulfilled product is available in the local product repository of the offline transaction system, providing the product information of the unfulfilled product in the local product repository to the user.

37. The computer-readable storage medium of claim 34, the providing product information of the unfulfilled product in the offline transaction system to the user comprising at least one of:
displaying, via a display screen of the offline transaction system, the product information of the unfulfilled product to the user; and
sending, via the online transaction system, the product information of the unfulfilled product to a client of the user for displaying to the user.
